(19) United States
(12) Patent Application Publication
(10) Pub. No.: US 2023/0196083 A1
(43) Pub. Date: Jun. 22, 2023

(54) METHODS AND SYSTEMS FOR PERFORMING STOCHASTIC COMPUTING USING NEURAL NETWORKS ON HARDWARE DEVICES

(71) Applicant: Secutopia Corporation, Paramus, NJ (US)

(72) Inventors: Myung Jong Lee, Paramus, NJ (US); Hasan Ahmed, Paramus, NJ (US)

(21) Appl. No.: 18/082,459

(22) Filed: Dec. 15, 2022

Related U.S. Application Data
(60) Provisional application No. 63/290,547, filed on Dec. 16, 2021.

(51) Int. Cl. G06N 3/047; G06N 3/08

(52) U.S. Cl. CPC G06N 3/047; G06N 3/08

(57) ABSTRACT

A method for training a system using stochastic computation is provided. The method includes receiving a first set of inputs and training, using the first set of inputs, a stochastic neural network having a series of activation layers and an output layer, including: before passing the first set of inputs to first activation layer in the series of activation layers, normalizing each input in the first set of inputs; and propagating the outputs from the first activation layer as inputs to a second activation layer in the series of activation layers, wherein the inputs to the second activation layer are normalized before being passed to the second activation layer.

### RELATED APPLICATION

This application claims priority to U.S. Provisional Patent Application Ser. No. 63/290,547, filed Dec. 16, 2021, entitled “Methods and Systems for Performing Stochastic Computing Using Neural Networks on Hardware Devices,” which is hereby incorporated by reference in its entirety.

### TECHNICAL FIELD

This application relates, in general, to stochastic computing, and in particular, to training a stochastic neural network for use in hardware.

### BACKGROUND OF INVENTION

With the enhancement of 5G-networks and embracement of Internet of Things (IoT) devices, new security threats are continuously popping up. In particular, the integration of weak, unsecured IoT devices into a main network makes the IoT device, and the entire network, even more unsecure.

Often, IoT devices have limited resources, including limited processing power, limited communication bandwidth, and limited storage capacity. The limited amount of resources available within IoT devices makes it more difficult to add security to the devices. Bad actors may hack into IoT devices to gain access to otherwise secure systems.

### BRIEF SUMMARY

Accordingly, there is a need for a host-based intrusion detection system that can easily be integrated with a variety of devices, including IoT devices with limited resources.

To boost the security of weakly secure IoT devices, described herein is a system with a small form factor, low energy consumption, and a hardware based HIDS (Host Intrusion Detection System). The HIDS can be adopted by a plurality of IoT devices without expanding the resource capabilities of the IoT device. Exploiting the advantage of Stochastic Computing (SC), a deep Neural Network Machine Learning algorithm runs in the hardware of the HIDS, making the HIDS a strong security measure (layer) added to a device.

In some implementations, in the training of the HIDS, in order to satisfy the constraint in stochastic computing (SC) to keep all variables within [−1, +1] margin, a method of calculating a Matrix Product, calculating an activation function and calculating a softmax function is provided.

Further, new SC hardware modules that are theoretically more accurate for a Neural network Algorithm (NNA) are introduced. In some implementations, typical issues that arise due to a limited number of Random Number Generators (RNG) required to do Binary Radix Computing (BC) to SC conversion are resolved using the disclosed implementations.

In some implementations, time synchronization is yet another issue, stemming from the mixture of combinational and sequential logic, that is resolved using the disclosed implementations. For example, a smart combination of digital counter and delay gates create perfect time synchronization.

In some implementations, the feature collection is generated in the software domain and integrated with the hardware (e.g., HIDS) with the help of Advanced eXtensible Interface 4 (AXI4) interface. Upon completing design of the HIDS, the performance of the HIDS was tested and compared with that of the software based one.

In some implementations, during testing, the performance of the SC hardware-based HIDS was found to perform essentially the same as a software-based (e.g., theoretical) intrusion detection system, which proves that the SC-based HIDS described herein is effective at preventing attacks from bad actors on an IoT that implements the HIDS.

To that end, in accordance with some implementations, a method for training a system using stochastic computation is provided. The method includes, at an electronic device (e.g., that is integrated with HIDS or another electronic device, such as a server, that is in communication with an IoT device that is integrated with HIDS), receiving a first set of inputs. The method includes training, using the first set of inputs, a stochastic neural network having a series of activation layers and an output layer, including: before passing the first set of inputs to first activation layer in the series of activation layers, normalizing each input in the first set of inputs; and propagating the outputs from the first activation layer as inputs to a second activation layer in the series of activation layers, wherein the inputs to the second activation layer are normalized before being passed to the second activation layer.

### BRIEF DESCRIPTION OF THE DRAWINGS

FIG. 1 illustrates a schematic diagram of a stochastic computing neural network algorithm in accordance with some implementations.

FIG. 2 illustrates a graph of comparative average margins for activation functions in accordance with some implementations.

FIG. 3 illustrates a graph of comparative full margin for output layer activation functions in accordance with some implementations.

FIGS. 4A and 4B illustrate block diagrams of a stochastic computing hardware block of Matrix Products in accordance with some implementations.

FIG. 5 illustrates a block diagram of a single selection, Selₙ, for each nth stage MUX in accordance with some implementations.

FIG. 6 illustrates stochastic computing sub blocks for an activation function in accordance with some implementations.

FIG. 7 illustrates a stochastic computing module for an activation function in accordance with some implementations.

FIG. 8 illustrates a stochastic computing block diagram for an activation function in accordance with some implementations.

FIG. 9 illustrates a simplified form of a four-output stochastic computing module for a new activation function in accordance with some implementations.

FIG. 10 illustrates a simulation for timing signals in accordance with some implementations.

FIG. 11 illustrates a detailed timing diagram in accordance with some implementations.

FIG. 12 illustrates a diagram of time synchronization in accordance with some implementations.

FIG. 13 illustrates a schematic diagram of a stochastic computing hardware system in accordance with some implementations.

FIG. 14 illustrates integration of various parts of a stochastic computing hardware system in accordance with some implementations.

FIG. 15 illustrates an example of a security threat in accordance with some implementations.

### DETAILED DESCRIPTION

Reference will now be made in detail to various implementations of the present invention(s), examples of which are illustrated in the accompanying drawings and described below. While the invention(s) will be described in conjunction with exemplary implementations, it will be understood that present description is not intended to limit the invention(s) to those exemplary implementations. On the contrary, the invention(s) is/are intended to cover not only the exemplary implementations, but also various alternatives, modifications, equivalents and other implementations, which may be included within the spirit and scope of the invention as defined by the appended claims.

The disclosed implementations relate to training a system for stochastic computation. For example, during the training process, a normalization block is inserted whereby training inputs are normalized before each layer of the neural network. For example, the initial training inputs are normalized to values of [−1, +1]. The weights take values of either +1 and −1 while the neural network is being trained (e.g., during forward propagation). At the end of the training, the final values are used in the backward propagation (to calculate next updated weights), but the integer values (converted to SC value) are used in the forward propagation to calculate the output of each NN layer (and the integer values are sent to the hardware as the trained update).

### Overview

The methods and systems described below provide details of a system, SC HIDS, including the process of training, testing, and detection. The steps include: a) training the HIDS with the help of Training Data Set and sending the updates (weights) to the device afterward, b) testing the updated HIDS via Testing Data Set in order to observe the performance, and c) implementing the HIDS into the device to detect live packets from real attack environment. In order to accomplish the whole task, first, a proper design of training algorithm compatible to SC domain is required. Then, a hardware design of the HIDS conforming to the training algorithm is implemented. Finally, a wrapper is created to extract the features from incoming packets, store the updates coming from the training server and output the decision of accept/reject to the proper agent.

### Challenges

Since the HIDS performance solely depends on proper SC domain training, strict compliance of the rules and characteristics of SC domain is employed. In some implementations, it is difficult to keep the Matrix Product calculation results for each NNA layer within [−1, +1]. In some implementations, the values of all the weights must also be within [−1, +1]. In some implementations, the number of weights resulting from the training and the number of NNA inputs together cannot exceed the maximum number of independent hardware RNGs (10-bit) that can be created.

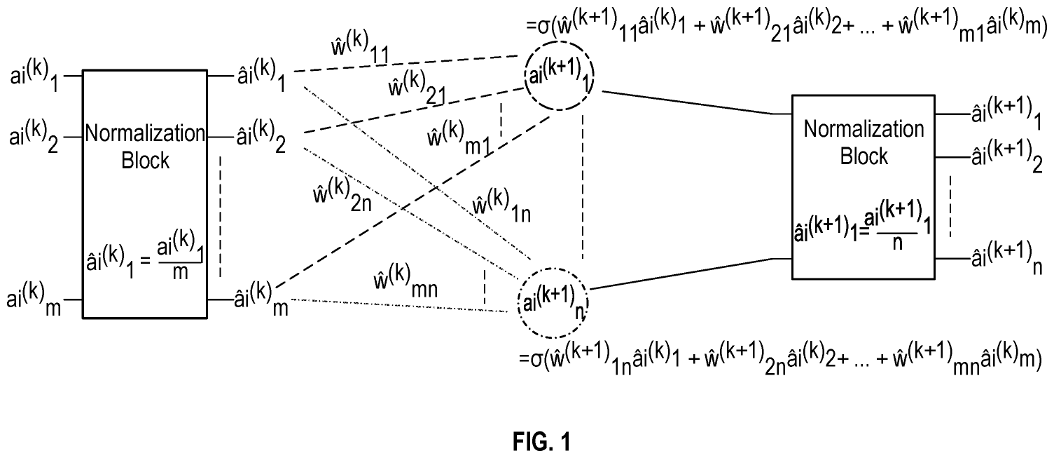

In some implementations, some performance issues that are arise due to the SC based approach required additional design considerations. For example, a set of smart modifications are used on BC based training so that it can emulate all SC domain characteristics. The methods described below will detail the changes and the efficacy of the modified training in regards to the performance of the SC HIDS system. A schematic diagram for SC NNA is shown in FIG. 1.

### Normalization Block for NNA Layer

The primary task of the SC training is to keep all the intermediate values, including that of the Matrix Product of BC, within SC range [+1, −1]. This necessitates creating a novel SC based Matrix Product in each layer of NNA and subsequent changes in the equations that follows:

$${s}_{i}^{k + 1} = \frac{{a}_{1}^{k} {\hat{w}}_{1 i}^{k + 1} + {a}_{2}^{k} {\hat{w}}_{2 i}^{k + 1} + … + {a}_{m}^{k} {\hat{w}}_{m i}^{k + 1}}{m} \leq 1 ; [ \vert a \vert \leq 1 , \vert w \vert \leq 1 ]$$

$${s}_{i}^{k + 1} = \frac{{\hat{a}}_{1}^{k} {\hat{w}}_{1 i}^{k + 1} + {\hat{a}}_{2}^{k} {\hat{w}}_{2 i}^{k + 1} + … + {\hat{a}}_{m}^{k} {\hat{w}}_{m i}^{k + 1}}{m} where {\hat{a}}^{k} = \frac{{a}^{k}}{m}$$

$${a}_{i}^{k + 1} = σ ( {s}_{i}^{k + 1} )$$

The additional stage

$${\hat{a}}^{k} = \frac{{a}^{k}}{m}$$

introduced newly in each NNA layer is termed as the Normalization Stage (Block). A succeeding adjustment in the backward propagation is to follow. Assuming the cost function has the form C=1/2*(aₙ^{k+1}−tₙ)²; where aₙ^{k+1} is the estimated value of output neuron n and to is the target value of output neuron, new equations for the backward propagation derivatives are as follows:

$$\frac{dC}{d {w}_{i , n}^{k + 1}} = {δ}_{n}^{k} * {\hat{a}}_{i}^{k} ; where {δ}_{n}^{k + 1} = {a}_{n}^{k + 1} * ( 1 - {a}_{n}^{k + 1} ) * ( {a}_{n}^{k + 1} - {t}_{n} ) ;$$

$$\frac{d C}{d {w}_{i , n}^{k}} = {δ}_{n}^{k} * {\hat{a}}_{i}^{k - 1} ;$$

$$where {δ}_{n}^{k} = {a}_{n}^{k} * ( 1 - {a}_{n}^{k} ) * \frac{1}{m} * {\sum }_{n} {δ}_{n}^{k + 1} * {w}_{i , n}^{k + 1} = {a}_{n}^{k} * ( 1 - {a}_{n}^{k} ) * {}^{‵} {δ}_{n}^{k}$$

### NNA Weights for SC Domain Training

In conventional NNA training, weights can have any value. However, for SC domain training, weights cannot go beyond a [−1, +1] range. Thus, training the HIDS while keeping the weights value within the prescribed range is considered the next big challenge. One way to overcome this challenge is to calculate the weights conventionally from backward propagation and later adjust the value within [−1, +1] by normalization. But since the NNA is a non-linear network, simple normalization will not reflect the actual weights. This will introduce significant error and these normalized weights will not represent the trained NNA network anymore.

In some implementations, another approach to overcome the challenge of keeping the weights value within the prescribed is to force the weights to take values either +1 or −1, while the NNA is being trained. In some implementations described below, this approach is used in the SC training. Since the update of weights is calculated from the backward propagation, updated weights change their values incrementally (not +1 or −1). As a result, at the end of each update, each weight will get a real number (value). But for the forward propagation, real valued weights are converted to either +1 or −1 (considered as SC weights, w_{SC}) employing a simple sign function f_{sign}.

$${w}_{S C} = {f}_{s i g n} ( {w}_{B C} ) = \{ \begin{matrix}+ 1 if {w}_{BC} > 0 \\ - 1 otherwise\end{matrix}$$

In some implementations, at the end of the training, all real valued weights are converted to SC valued weights w_{SC}, and are sent to the HIDS as the trained update. While the real valued weight W_{BC} is used in the backward propagation to calculate the next updated weights, integer valued w_{SC} is used in the forward propagation to calculate output (error) of each NNA layer. Thus, the Matrix Product calculation in the forward pass takes the following shape:

$${s}_{i}^{k + 1} = {\hat{a}}_{1}^{k} {w}_{S {C}_{1 i}}^{k + 1} + {\hat{a}}_{2}^{k} {w}_{S {C}_{2 i}}^{k + 1} + … + {\hat{a}}_{m}^{k} {w}_{{SC}_{m i}}^{k + 1}$$

$${a}_{i}^{k + 1} = σ ( {s}_{i}^{k + 1} )$$

$${δ}_{n}^{k + 1} = {a}_{n}^{k + 1} * ( 1 - {a}_{n}^{k + 1} ) * ( {a}_{n}^{k + 1} - {t}_{n} ) ;$$

$${δ}_{n}^{k} = {a}_{n}^{k} * ( 1 - {a}_{n}^{k} ) * \frac{1}{m} * {\sum }_{n} {δ}_{n}^{k + 1} * {w}_{B {C}_{i , n}}^{k + 1} ;$$

$$Δ {w}_{B C} = \frac{d C}{d {w}_{{( B C )}_{i , n}}^{k}} = {δ}_{n}^{k} * {\hat{a}}_{i}^{k - 1}$$

$${w}_{B C}^{n e w} = {w}_{B C}^{old} - Δ {w}_{B C}$$

In some implementations, at the start of the training, a set of initial weights are used for forward and backward propagation. The initialization of weight is also impacted by these two sets of weights. Primarily, the initialization function provides the start values of W_{BC}. In some implementations, this function is a uniform random function with the range [−0.5,+0.5]. The start values of w_{SC} on the other hand, is generated utilizing the sign function, f_sign(w_{SC}) After every batch of iteration, w_{BC} is updated to a new value. For a better convergence, the number of iterations may go very high. As such, the value of W_{BC} may increase to some unreasonable ones. In some implementations, the values of W_{BC} beyond the range [−1, +1] do not impact the update process any more since W_{BC} holds either −1 or +1. Thus, another function termed as clip function with the following form is used to keep W_{BC} within the range of SC domain:

$${w}_{B C} = {f}_{clip} ( {w}_{B C} ) = \{ \begin{matrix}+ 1 if {w}_{B C} > + 1 \\ - 1 if {w}_{B C} < - 1 \\ {w}_{B C} otherwise\end{matrix}$$

### New Activation Function: SCigmoid

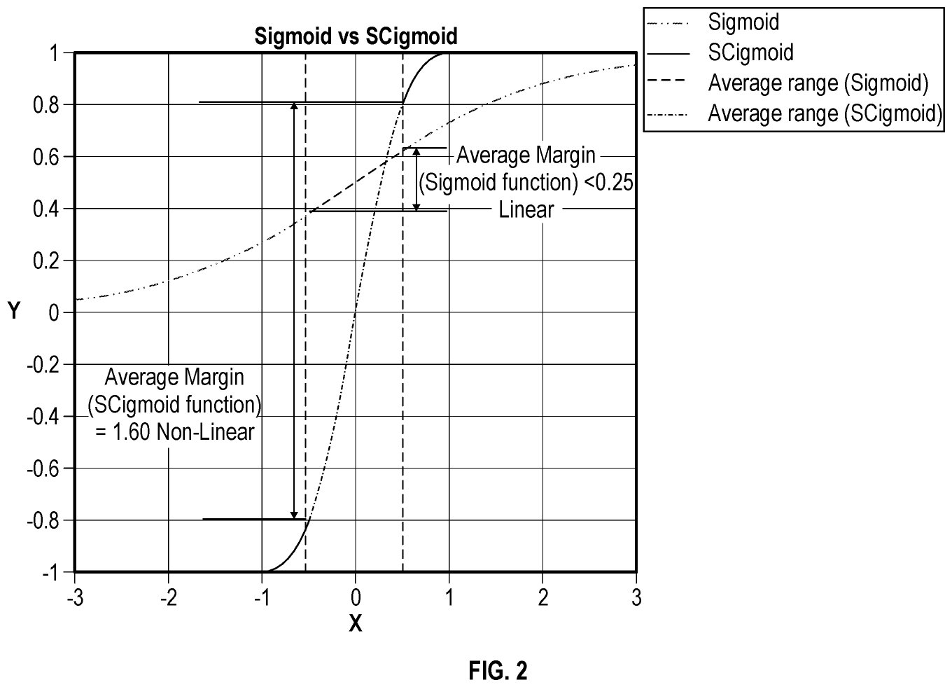

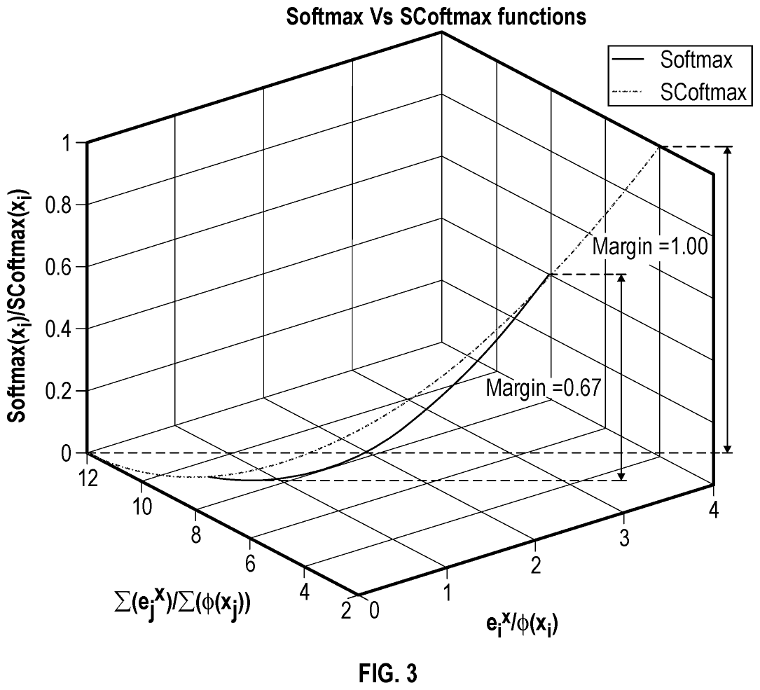

In some implementations, a Taylor series approximation of the activation function Sigmoid(x)=1/(1+e−x) is employed for the SC domain training. Taking the advantage of SC domain range [−1, 1], the approximation of the function appears to be Sigmoid(x)≈(x/2+1)/2 (when −1≤x≤1). However, this design had two serious issues: a) the activation function is no longer a non-linear function (not suitable for any NNA network); and b) the average range of values of Sigmoid(x) that are within SC range is less than 0.3, despite the full SC margin of 2.0 [−1,+1] (FIG. 2). In some implementations, a new SC domain activation function was used instead: SCigmoid with the following form:

$$SCigmoid ( x ) = \frac{{( 1 + x )}^{2} - {( 1 - x )}^{2}}{{( 1 + x )}^{2} + {( 1 - x )}^{2}} ; where - 1 \leq x \leq + 1$$

The above expression has two significant advantages: a) the average range of values for the activation function SCigmoid is now 1.60; and b) SC hardware design of the function is simple and only required two NOT gates, two AND gates, two one-bit Delay gate and one JK flip-flop. The SC module for SCigmoid function is described in more detail below. As for the SC training, the backward propagation requires the derivative of this new activation function in order to calculate the updated weights;

$${f}^{′} ( x ) = f ( x ) ( \frac{1}{x} - f ( x ) ) [ - 1 \leq x \leq + 1 ] ;$$

$$where f ( x ) = \frac{{( 1 + x )}^{2} - {( 1 - x )}^{2}}{{( 1 + x )}^{2} + {( 1 - x )}^{2}} [ - 1 \leq x \leq + 1 ]$$

This new activation function SCigmoid brings subsequent changes in the calculations of weight updates:

$${δ}_{n}^{k + 1} = ( {a}_{n}^{k + 1} - {t}_{n} ) * {a}_{n}^{k + 1} ( \frac{1}{{s}_{n}^{k + 1}} - {a}_{n}^{k + 1} ) * {δ}_{n}^{k} = {a}_{n}^{k} * ( \frac{1}{{s}_{n}^{k}} - {a}_{n}^{k} ) * \frac{1}{m} * {\sum }_{n} {δ}_{n}^{k + 1} * {w}_{B {C}_{i , n}}^{k + 1}$$

### Output Layer Activation Function: SCoftmax

After finding a new activation function SCigmoid for SC domain NNA layer, the training algorithm is designed. For example, using the softmax function at the output layer (instead of SCigmoid) improves the overall performance of the training algorithm. However, the validity of the softmax function in SC domain was a real concern. For example, softmax function brings issues similar to the issues of sigmoid function, especially when applying in SC domain. Thus, a new output layer activation function is provided herein. In some implementations, a new softmax function for SC NNA is used as the output layer activation function. This novel softmax function named SCoftmax, has the following expression:

$$SCoftmax ( {x}_{i} ) = \frac{ϕ ( {x}_{i} )}{{\sum }_{j}^{n} ϕ ( {x}_{j} )} ; where ϕ ( {x}_{i} ) = {( 1 + {x}_{i} )}^{2}$$

This new output layer activation function SCoftmax now provides two additive advantages: a) the values for this output activation function can range from 0 to 1 (full range); and b) a simple and accurate SC module of this function requires a limited number of digital gates (discussed later). This new activation function however brings changes in the derivation of the backward propagation, especially at the output layer:

$${a}_{i} = SCoftmax ( {s}_{i} ) = \frac{ϕ ( {s}_{i} )}{{\sum }_{k}^{n} ϕ ( {s}_{k} )} ; where ϕ ( {s}_{i} ) = {( 1 + {s}_{i} )}^{2}$$

$$\frac{d ( {a}_{i} )}{d {s}_{i}} = \frac{2}{1 + {s}_{i}} \cdot {a}_{i} ( 1 - {a}_{i} )$$

$$\frac{d ( {a}_{j} )}{d {s}_{i}} = - \frac{2}{1 + {s}_{i}} \cdot {a}_{i} {a}_{j}$$

$$\frac{d C}{d {w}_{B {C}_{r , i}^{( k + 1 )}}} = {δ}_{i}^{k + 1} * {\hat{a}}_{r}^{k}$$

In the anticipation of dynamic nature of cyberattacks, the proposed HIDS is built on Machine Learning Neural Network Algorithm (NNA) in SC domain. In some implementations, a new HIDS hardware design that is compatible and harmonized with the expressions and equations of the new SC training algorithm is described below.

### Evolution of Matrix Product Module

In some implementations, the proposed SC hardware module for Matrix Product (inner-product) was initially designed using the following expression:

$$W \cdot X = \frac{1}{( \vert {x}_{1} \vert + … + \vert {x}_{m} \vert )} ( {w}_{1} {x}_{1} + … + {w}_{m} {x}_{m} ) α ( {w}_{1} {x}_{1} + … + {w}_{m} {x}_{m} )$$

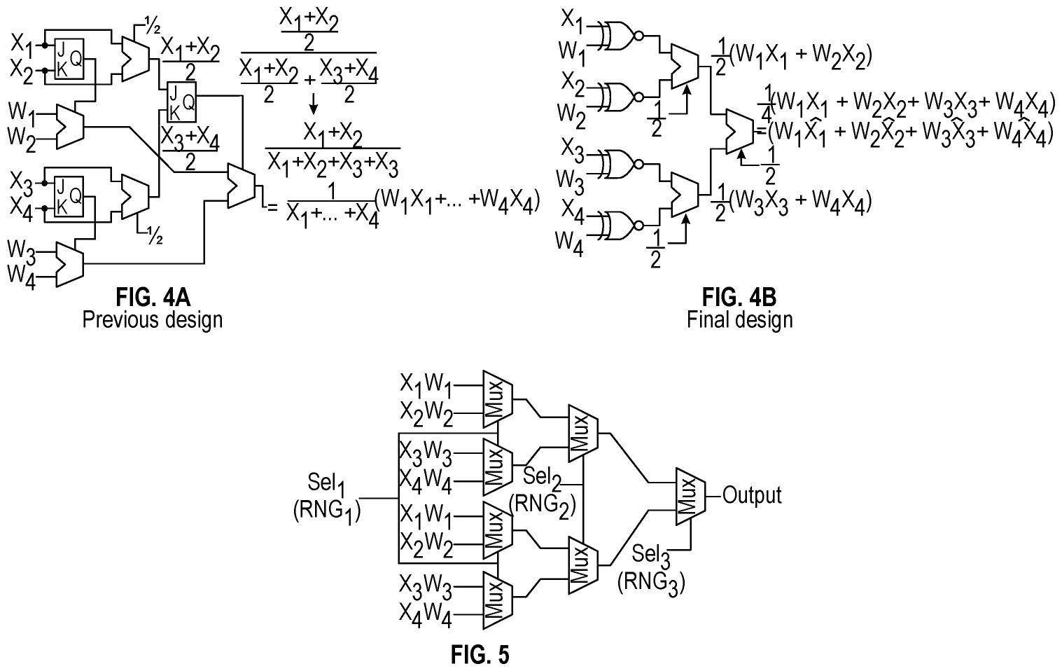

However, a caveat regarding this module, which is illustrated in FIG. 4A, was discovered whereby since input data features for each packet is different, the proportionality constant for matrix product for each data packet happens to be different:

$$\frac{{W}^{( 1 )} \cdot {X}^{( 1 )}}{{W}^{( 2 )} \cdot {X}^{( 2 )}} \neq \frac{( {w}_{1}^{( 1 )} {x}_{1}^{( 1 )} + … + {w}_{m}^{( 1 )} {x}_{m}^{( 1 )} )}{( {w}_{1}^{( 2 )} {x}_{1}^{( 2 )} + … + {w}_{m}^{( 2 )} {x}_{m}^{( 2 )} )}$$

Therefore, in some implementations, instead of

$$\frac{1}{( \vert {x}_{1} \vert + … + \vert {x}_{m} \vert )} ,$$

$$\frac{1}{( \vert {w}_{1} \vert + … + \vert {w}_{m} \vert )}$$

is used as the proportionality constant for the new Matrix Product.

Moreover, in some implementations, w_{sc} weights are used for forward propagation of the NNA. In some implementations (e.g., during normal operation of HIDS), only the forward propagation takes place. Thus, the elements of the weight vector W(=w_{sc}) will have values of either +1 or −1. As a result, the new expression of the SC Matrix Product is as follows:

$$W \cdot X = \frac{1}{( \vert {w}_{s {c}_{1}} \vert + … + \vert {w}_{s {c}_{m}} \vert )} ( {w}_{s {c}_{1}} {x}_{1} + … + {w}_{s {c}_{m}} {x}_{m} ) = \frac{1}{m} ( {w}_{s {c}_{1}} {x}_{1} + … + {w}_{s {c}_{m}} {x}_{m} ) \\$$

$$where ( \vert {w}_{s {c}_{1}} \vert + … + \vert {w}_{s {c}_{m}} \vert ) = 1 + 1 + … + 1 = m$$

This expression is exactly the same as Matrix Product of the SC training algorithm introduced above:

$${s}_{i}^{k + 1} = \frac{( {a}_{1}^{k} {w}_{{SC}_{1 i}}^{k + 1} + {a}_{2}^{k} {w}_{{SC}_{2 i}}^{k + 1} + … + {a}_{m}^{k} {w}_{{SC}_{m i}}^{k + 1} )}{m} = {\hat{a}}_{1}^{k} {w}_{{SC}_{1 i}}^{k + 1} + {\hat{a}}_{2}^{k} {w}_{{SC}_{2 i}}^{k + 1} + … + {a}_{m}^{k} {w}_{{SC}_{m i}}^{k + 1}$$

$$where {a}_{i}^{k} = \frac{{a}_{i}^{k}}{m}$$

The new SC hardware block of Matrix Product (4-input) has taken the form shown in FIG. 4B. When the new SC Matrix Product block in FIG. 4B is compared with the old matrix product block illustrated in FIG. 4A, there are multiple advantages of the new SC Matrix Product block in FIG. 4B. First, the design in FIG. 4B reduces the silicon space by a ratio of 4:3 (NAND gate counts) from the previous one (FIG. 4A) when considering 4-input Matrix Product. Second, the new design in FIG. 4B has no sequential logic gate, thus no delay and no synchronization issues. Moreover, the SC hardware design in FIG. 4B produces exactly the same expression that is adopted in the training algorithm. Further, the inputs x now consider bipolar values, thus occupying the full SC space of −1 to +1. This provides more room for better convergence.

Now that the SC module is created for the Matrix Product, in some implementations, the probabilities of different inputs maintain their independence. Assuming the Random Number Generators (RNGs) that are employed to generate the SC values of x₁, w₁, x₂, w₂ . . . are independent, the output of each XNOR will produce xₙ*wₙ (FIG. 4B). Since SC value of Mux selection is half (1/2), the probability that the value of selection Sel=1 is p₁=1/2 and the probability that the value of selection Sel=0 is p₀=1/2. Therefore, the output of the first Mux in FIG. 4B will either be x₁w₁ if Sel=1 or x₂w₂ if Sel=0. The probability that the output is x₁w₁=x₁w₁*p₁=1/2x₁w₁ and the probability that the output is x₂w₂=x₂w₂*p₀=−1/2x₂w₂. At any given time, the output of Mux will be either x₁w₁ or x₂w₂ (e.g., the only possibilities). Applying the same calculation for all the Mux's in FIG. 4B, the final output should be equal to 1/4(x₁w₁+x₂w₂+x₃w₃+x₄w₄). Initially, the selection inputs Sels (SC half) are produced from separate (independent) RNGs. However, it is theoretically confirmed that if the RNGs of Sels of different stages are kept independent (FIG. 5), the output of the Matrix Product will still be equal to 1/4(x₁w₁+x₂w₂+x₃w₃+x₄w₄) (e.g., the same equation of the Matrix Product of the training system:

$$Output = ( {x}_{1} {w}_{1} + … + {x}_{n} {w}_{n} ) * \frac{1}{n} = ( {\hat{x}}_{1} {w}_{1} + … + {\hat{x}}_{n} {w}_{n} ) = s ) .$$

As a result, the number of RNGs required to be used in the system is decreased from 15 to 3 (for 15 inputs), while maintaining the equation of Matrix Product of the training system.

### Activation Function: SCigmoid

In some implementations, the design of activation function is updated from the initial design described above (e.g., because of the issues with the previous design and the advantages of the new design explained above). The mathematical expression for this novel activation function SCigmoid has the following form:

$$SCigmoid ( x ) = \frac{{( 1 + x )}^{2} - {( 1 - x )}^{2}}{{( 1 + x )}^{2} + {( 1 - x )}^{2}} ; where - 1 \leq x \leq + 1$$

Assuming the following notations for the SC bipolar unipolar conversion, the hardware design of the SCigmoid function is presented in detail below.

$${f}_{u} ( {x}_{b} ) = {( \frac{1}{2} + \frac{{x}_{b}}{2} )}_{u} = {( \frac{1}{2} ( 1 + {x}_{b} ) )}_{u} where input {x}_{b} is in bipolar and the output is in unipolar$$

$${f}_{b} ( {x}_{u} ) = {( 2 {x}_{u} - 1 )}_{b} where input {x}_{u} is in unipolar and the output is in bipolar ,$$

Steps (submodules) to create the new SCigmoid function in SC domain; x is considered as the input.

$${f}_{u} ( x ) \to {〈 \frac{1}{2} + \frac{x}{2} 〉}_{u} = {〈 \frac{1}{2} ( 1 + x ) 〉}_{u} : no additional gate$$

$${f}_{u} ( - x ) \to {〈 \frac{1}{2} + \frac{- x}{2} 〉}_{u} = {〈 \frac{1}{2} ( 1 - x ) 〉}_{u} : one NOT gate$$

$${〈 \frac{1}{2} ( 1 + x ) 〉}_{u} \to {〈 {[ \frac{1}{2} ( 1 + x ) ]}^{2} 〉}_{u} = {f}_{u}^{2} ( x ) : one AND gate with one bit delay$$

$${〈 \frac{1}{2} ( 1 + x ) 〉}_{u} \to {〈 {[ \frac{1}{2} ( 1 - x ) ]}^{2} 〉}_{u} = {f}_{u}^{2} ( - x ) : one AND gate with one bit delay$$

$$\{ {〈 {[ \frac{1}{2} ( 1 + x ) ]}^{2} 〉}_{u} , {〈 {[ \frac{1}{2} ( 1 - x ) ]}^{2} 〉}_{u} \} \to {〈 \frac{{[ \frac{1}{2} ( 1 - x ) ]}^{2}}{{[ \frac{1}{2} ( 1 - x ) ]}^{2} + {[ \frac{1}{2} ( 1 + x ) ]}^{2}} 〉}_{u} = {〈 \frac{{[ ( 1 - x ) ]}^{2}}{{[ ( 1 + x ) ]}^{2} + {[ ( 1 - x ) ]}^{2}} 〉}_{u} = \frac{{f}_{u}^{2} ( - x )}{{f}_{u}^{2} ( x ) + {f}_{u}^{2} ( - x )} : one JK flipflop$$

$${f}_{b} ( \frac{{[ ( 1 - x ) ]}^{2}}{{[ ( 1 + x ) ]}^{2} + {[ ( 1 - x ) ]}^{2}} ) \to {〈 2 ⋆ ( \frac{{[ ( 1 - x ) ]}^{2}}{{[ ( 1 + x ) ]}^{2} + {[ ( 1 - x ) ]}^{2}} ) - 1 〉}_{b} = {〈 \frac{{[ ( 1 - x ) ]}^{2} - {[ ( 1 + x ) ]}^{2}}{{[ ( 1 + x ) ]}^{2} + {[ ( 1 - x ) ]}^{2}} 〉}_{b} = {f}_{b} ( \frac{{f}_{u}^{2} ( - x )}{{f}_{u}^{2} ( x ) + {f}_{u}^{2} ( - x )} ) : no additional gate$$

$${〈 - \frac{{[ ( 1 - x ) ]}^{2} - {[ ( 1 + x ) ]}^{2}}{{[ ( 1 + x ) ]}^{2} + {[ ( 1 - x ) ]}^{2}} 〉}_{b} = {〈 \frac{{[ ( 1 - x ) ]}^{2} - {[ ( 1 + x ) ]}^{2}}{{[ ( 1 + x ) ]}^{2} + {[ ( 1 - x ) ]}^{2}} 〉}_{b} = - {f}_{b} ( \frac{{f}_{u}^{2} ( - x )}{{f}_{u}^{2} ( x ) + {f}_{u}^{2} ( - x )} ) : one NOT gate$$

$$SCigmoid = - {f}_{b} ( \frac{{f}_{u}^{2} ( - {x}_{b} )}{{f}_{u}^{2} ( {x}_{b} ) = {f}_{u}^{2} ( - {x}_{b} )} ) = \frac{{( 1 + x )}^{2} - {( 1 - x )}^{2}}{{( 1 + x )}^{2} + {( 1 - x )}^{2}}$$

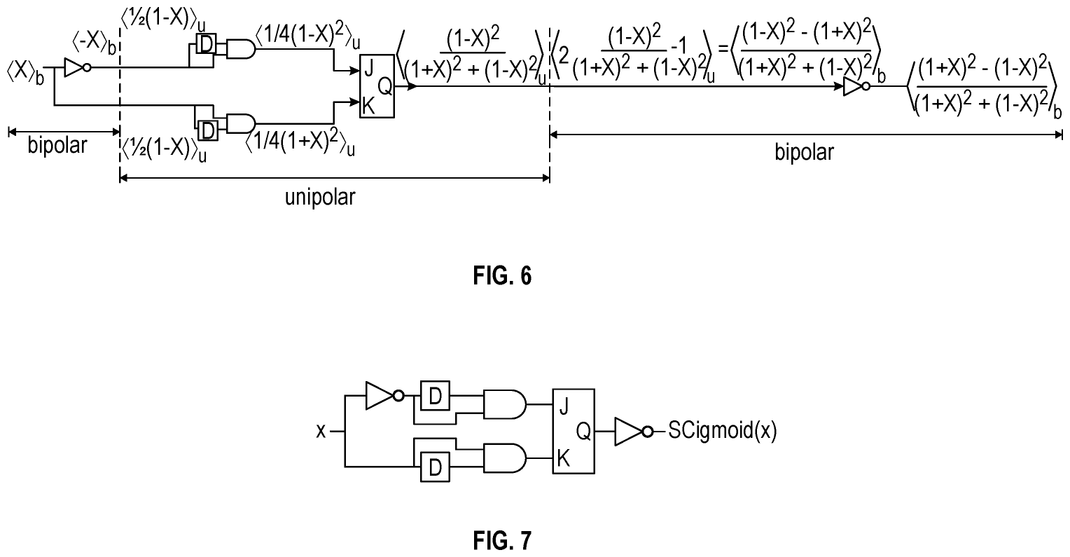

The SC sub-modules of the new activation function are shown in FIG. 6 with its unipolar and bipolar regions. Even though the whole module requires both unipolar and bipolar sub-module operations, the incoming and the outgoing value of the SCigmoid module is always bipolar. Thus, the module is transparent to the SC NNA. The simplified form of the module is shown in FIG. 7.

### Solution For Limited Number of RNGS

The first step for any SC operation is to convert all BC values to its SC counterparts with the help of RNGs. Thus all the input variables to the NNA system need to be converted to SC. Each conversion of BC to SC requires one 10-bit RNG and one 10-bit comparator. However, the number of hardware RNGs (made from Linear Feedback Shift Register (LFSR)) is not unlimited. In fact, the numbers of independent 10-bit RNGs that can be made from LFSR are no more than 60 (two 2-tap combinations, twenty 4-tap combinations, twenty eight 6-tap combinations and ten 8-tap combinations). To increase the number of independent RNGs, previous implementations utilized a shuffle network and can create three independent RNGs out of each LFSR. As such, the maximum number of 10-bit RNGs, using the previous implementations, will be no more than 180. Since the number of input features for the SC NNA design described herein is 15, an equal number of RNGs (e.g., 15 RNGs) is required. The remaining 165 (e.g., 180-15) RNGs can be utilized to convert the weights. Each layer of weights form a matrix of weight vector with number of rows is equal to the number of inputs and the number of columns is equal to the number of outputs (e.g., neurons). As such, with 165 RNGs, a weight vector of 15×11 can be created. In other words, the limited number of RNGs forces the NNA network to be a 15-input and 11-output network without having any hidden layers. Such NNA cannot provide training or normal operation of HIDS in any real sense.

A simple and elegant solution for this difficult issue came from the fact that the forward weights (wsc) only take values either +1 or −1 as discussed in the previous section. The conversion of −1/+1 of BC to its SC bipolar can be expressed by the following equation.

$$x = 2 ( \frac{X}{N} ) - 1 where X is N number of 1 ' s or$$

$$x = 1 and all 0 for x = - 1$$

For a 10-bit SC, the value of N is 210=1024. Thus, by definition, +1 in BC is represented by all 1's, while the −1 is represented by all 0's is SC. Therefore, the conversion of weight values from BC to SC does not require RNGs and/or Comparators. Rather, a 1-bit value of 1 (e.g., or 0) is tied to the HIDS so that it reads a value 1 (e.g., or 0) for each tick of the clock (e.g., all 1's and 0's) for BC value of +1 (e.g., or −1). This lifts the restriction to the number of NNA weights so that a viable deep neural network can be designed for SC HIDS.

### Output Layer Activation Function: SCoftmax

During the HIDS training, improvements the convergence resulted in a brand new output layer activation function, referred to herein as SCoftmax. In some implementations, one normal and three attack types are considered (e.g., for testing). Thus, the definition of the new SCoftmax function considering four output classes is as follows:

$$SCoftmax ( {x}_{i} ) = \frac{ϕ ( {x}_{i} )}{{\sum }_{j}^{n} ϕ ( {x}_{j} )} ; where ϕ ( {x}_{i} ) = {( 1 + {x}_{i} )}^{2}$$

Steps (submodules) to create the new SCoftmax function in SC domain; x is considered as the input.

$${{f}_{u} ( {x}_{i} ) \to 〈 \frac{1}{2} + \frac{{x}_{i}}{2} )}_{u} = {〈 \frac{1}{2} ( 1 + {x}_{i} ) 〉}_{u} : no additional gate$$

$${〈 \frac{1}{2} ( 1 + {x}_{i} ) 〉}_{u} \to {〈 \frac{1}{4} {( 1 + {x}_{i} )}^{2} 〉}_{u} = {〈 \frac{1}{4} ϕ ( {x}_{i} ) 〉}_{u} : one AND and one Delay gate$$

$$\{ {〈 \frac{1}{4} ϕ ( {x}_{1} ) 〉}_{u} , {〈 \frac{1}{4} ϕ ( {x}_{2} ) 〉}_{u} \} \to {〈 \frac{ϕ ( {x}_{1} ) + ϕ ( {x}_{2} )}{8} 〉}_{u} : one MUX gate$$

$$\{ {〈 \frac{1}{4} ϕ ( {x}_{3} ) 〉}_{u} , {〈 \frac{3}{4} ϕ ( {x}_{4} ) 〉}_{u} \} \to {〈 \frac{ϕ ( {x}_{3} ) + ϕ ( {x}_{4} )}{8} 〉}_{u} : one MUX gate$$

$$\{ {〈 \frac{1}{4} ϕ ( {x}_{1} ) 〉}_{u} , {〈 \frac{1}{4} ϕ ( {x}_{2} ) 〉}_{u} \} \to {〈 \frac{ϕ ( {x}_{1} )}{ϕ ( {x}_{1} ) + ϕ ( {x}_{2} )} 〉}_{u} : one JK flip - flop$$

$$\{ {〈 \frac{1}{4} ϕ ( {x}_{3} ) 〉}_{u} , {〈 \frac{3}{4} ϕ ( {x}_{4} ) 〉}_{u} \} \to {〈 \frac{ϕ ( {x}_{3} )}{ϕ ( {x}_{3} ) + ϕ ( {x}_{4} )} 〉}_{u} : one JK flip - flop$$

$${〈 \frac{ϕ ( {x}_{1} )}{ϕ ( {x}_{1} ) + ϕ ( {x}_{2} )} 〉}_{u} \to {〈 \frac{ϕ ( {x}_{2} )}{ϕ ( {x}_{1} ) + ϕ ( {x}_{2} )} 〉}_{u} : one NOT gate$$

$${〈 \frac{ϕ ( {x}_{3} )}{ϕ ( {x}_{3} ) + ϕ ( {x}_{4} )} 〉}_{u} \to {〈 \frac{ϕ ( {x}_{4} )}{ϕ ( {x}_{3} ) + ϕ ( {x}_{4} )} 〉}_{u} : one NOT gate$$

$$\{ {〈 \frac{ϕ ( {x}_{1} ) + ϕ ( {x}_{2} )}{8} 〉}_{u} , {〈 \frac{ϕ ( {x}_{3} ) + ϕ ( {x}_{4} )}{8} 〉}_{u} \} \to {〈 \frac{ϕ ( {x}_{1} ) + ϕ ( {x}_{2} )}{ϕ ( {x}_{1} ) + ϕ ( {x}_{2} ) + ϕ ( {x}_{3} ) + ϕ ( {x}_{4} )} 〉}_{u} : one JK flip - flop$$

$${〈 \frac{ϕ ( {x}_{1} ) + ϕ ( {x}_{2} )}{ϕ ( {x}_{1} ) + ϕ ( {x}_{2} ) + ϕ ( {x}_{3} ) + ϕ ( {x}_{4} )} 〉}_{u} \to {〈 \frac{ϕ ( {x}_{3} ) + ϕ ( {x}_{4} )}{ϕ ( {x}_{1} ) + ϕ ( {x}_{2} ) + ϕ ( {x}_{3} ) + ϕ ( {x}_{4} )} 〉}_{u} : one NOT gate$$

$$\{ {〈 \frac{ϕ ( {x}_{1} ) + ϕ ( {x}_{2} )}{ϕ ( {x}_{1} ) + ϕ ( {x}_{2} ) + ϕ ( {x}_{3} ) + ϕ ( {x}_{4} )} 〉}_{u} , {〈 \frac{ϕ ( {x}_{1} )}{ϕ ( {x}_{1} ) + ϕ ( {x}_{2} )} 〉}_{u} \} \to {〈 \frac{ϕ ( {x}_{1} )}{ϕ ( {x}_{1} ) + ϕ ( {x}_{2} ) + ϕ ( {x}_{3} ) + ϕ ( {x}_{4} )} 〉}_{u} : one AND gate$$

$$\{ {〈 \frac{ϕ ( {x}_{1} ) + ϕ ( {x}_{2} )}{ϕ ( {x}_{1} ) + ϕ ( {x}_{2} ) + ϕ ( {x}_{3} ) + ϕ ( {x}_{4} )} 〉}_{u} , {〈 \frac{ϕ ( {x}_{2} )}{ϕ ( {x}_{1} ) + ϕ ( {x}_{2} )} 〉}_{u} \} \to {〈 \frac{ϕ ( {x}_{2} )}{ϕ ( {x}_{1} ) + ϕ ( {x}_{2} ) + ϕ ( {x}_{3} ) + ϕ ( {x}_{4} )} 〉}_{u} : one AND gate$$

$$\{ {〈 \frac{ϕ ( {x}_{3} ) + ϕ ( {x}_{4} )}{ϕ ( {x}_{1} ) + ϕ ( {x}_{2} ) + ϕ ( {x}_{3} ) + ϕ ( {x}_{4} )} 〉}_{u} , {〈 \frac{ϕ ( {x}_{3} )}{ϕ ( {x}_{3} ) + ϕ ( {x}_{4} )} 〉}_{u} \} \to {〈 \frac{ϕ ( {x}_{3} )}{ϕ ( {x}_{1} ) + ϕ ( {x}_{2} ) + ϕ ( {x}_{3} ) + ϕ ( {x}_{4} )} 〉}_{u} : one AND gate$$

$$\{ {〈 \frac{ϕ ( {x}_{3} ) + ϕ ( {x}_{4} )}{ϕ ( {x}_{1} ) + ϕ ( {x}_{2} ) + ϕ ( {x}_{3} ) + ϕ ( {x}_{4} )} 〉}_{u} , {〈 \frac{ϕ ( {x}_{4} )}{ϕ ( {x}_{3} ) + ϕ ( {x}_{4} )} 〉}_{u} \} \to {〈 \frac{ϕ ( {x}_{4} )}{ϕ ( {x}_{1} ) + ϕ ( {x}_{2} ) + ϕ ( {x}_{3} ) + ϕ ( {x}_{4} )} 〉}_{u} : one AND gate$$

The four output classes of the SCoftmax function modules in SC domain are:

$${〈 \frac{ϕ ( {x}_{1} )}{ϕ ( {x}_{1} ) + ϕ ( {x}_{2} ) + ϕ ( {x}_{3} ) + ϕ ( {x}_{4} )} 〉}_{u} = {〈 \frac{ϕ ( {x}_{1} )}{{\sum }_{j}^{n} ϕ ( {x}_{j} )} 〉}_{u} = SCoftmax ( {x}_{1} )$$

$${〈 \frac{ϕ ( {x}_{2} )}{ϕ ( {x}_{1} ) + ϕ ( {x}_{2} ) + ϕ ( {x}_{3} ) + ϕ ( {x}_{4} )} 〉}_{u} = {〈 \frac{ϕ ( {x}_{2} )}{{\sum }_{j}^{n} ϕ ( {x}_{j} )} 〉}_{u} = SCoftmax ( {x}_{2} )$$

$${〈 \frac{ϕ ( {x}_{3} )}{ϕ ( {x}_{1} ) + ϕ ( {x}_{2} ) + ϕ ( {x}_{3} ) + ϕ ( {x}_{4} )} 〉}_{u} = {〈 \frac{ϕ ( {x}_{3} )}{{\sum }_{j}^{n} ϕ ( {x}_{j} )} 〉}_{u} = SCoftmax ( {x}_{3} )$$

$${〈 \frac{ϕ ( {x}_{4} )}{ϕ ( {x}_{1} ) + ϕ ( {x}_{2} ) + ϕ ( {x}_{3} ) + ϕ ( {x}_{4} )} 〉}_{u} = {〈 \frac{ϕ ( {x}_{4} )}{{\sum }_{j}^{n} ϕ ( {x}_{j} )} 〉}_{u} = SCoftmax ( {x}_{4} )$$

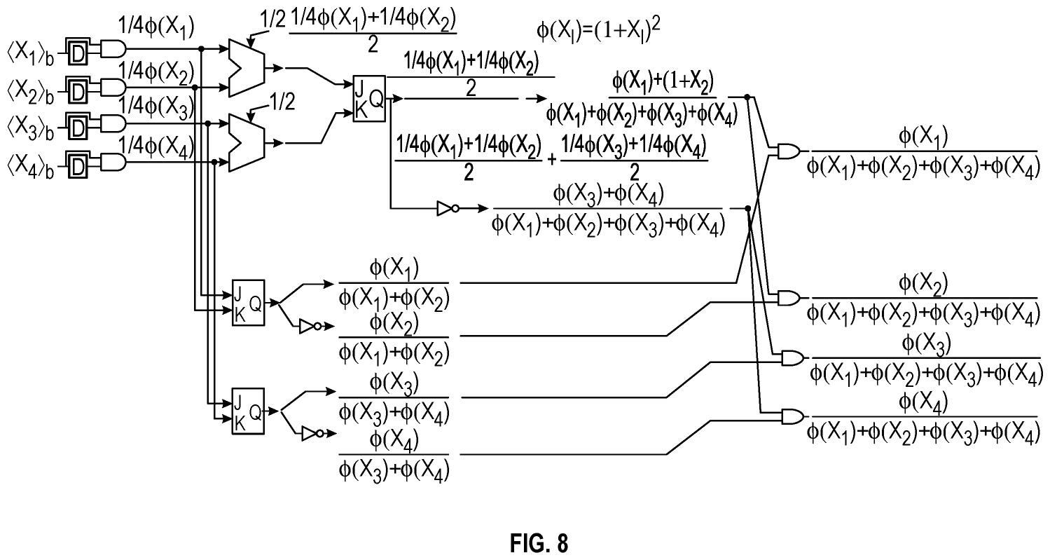

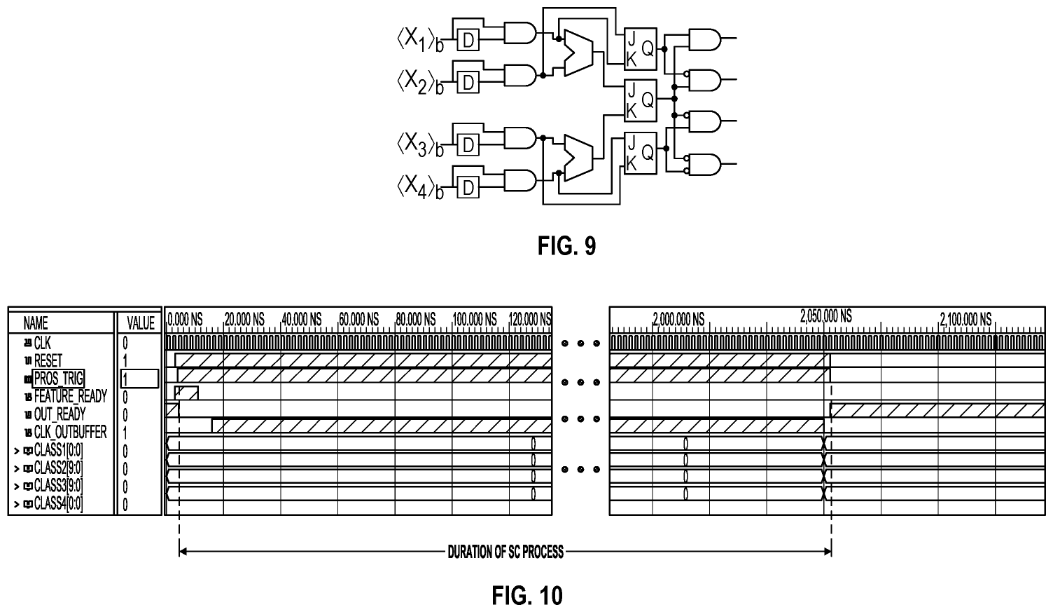

The SCoftmax SC hardware design module is shown in FIG. 8. The simplified form of the four-output SCoftmax is depicted in FIG. 9.

### Time Synchronization of the whole SC Process

Since the SC process involves 1024 (e.g., N=210) serial-bit operations of each variable, all the SC values need to be held unchanged during the 1024 clock cycles. Moreover, in some implementations, the process should start only after the features from incoming packets are sent (feature ready) to the HIDS through an API (discussed below). In addition, after the process completion and output is ready to read, an output ready (out_ready) signal is activated in order to read the output through the API. In some implementations, an FPGA timing module was created with clock and feature_ready as inputs and out_ready as output. A Module is designed using a 10-bit counter (e.g., that counts from 0 to 1023) to complete 1024 cycles count. However, during this time, all the weights and features are required to be kept unchanged. Thus, a new signal named pros_trig was created to hold all the values in the buffer during the SC process (1024 clock cycles). Moreover, when the output is ready to read, a signal named clk_buffer holds the output values (e.g., classes) in the output buffer so that the decision module can complete the reading correctly. In some implementations, Xilinx FPGA is used, and the Vivado software platform offered by Xilinx is also used. Besides FPGA design and implementation, an accurate simulation environment is provided by Vivado platform in order to verify the design before implementing. A simulation for the timing block with all the timing signals was checked and verified beforehand. The simulation for this timing signals is shown in FIG. 10.

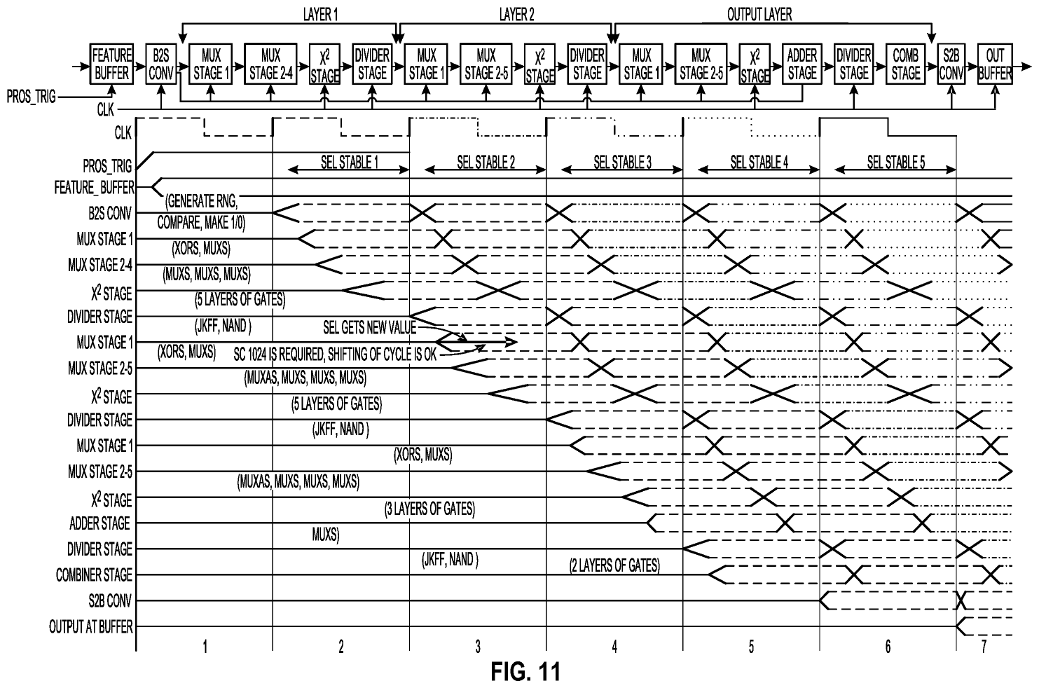

However, since some of the modules (e.g., activation functions and others) have sequential blocks (e.g., flip-flop), delays are introduced in each cycle of the clock. As a result, the process has to account all the delays and generates the out ready signal at the right time. Thus, in some implementations, a correct timing diagram, illustrated in FIG. 11, is used to address this timing mismatch.

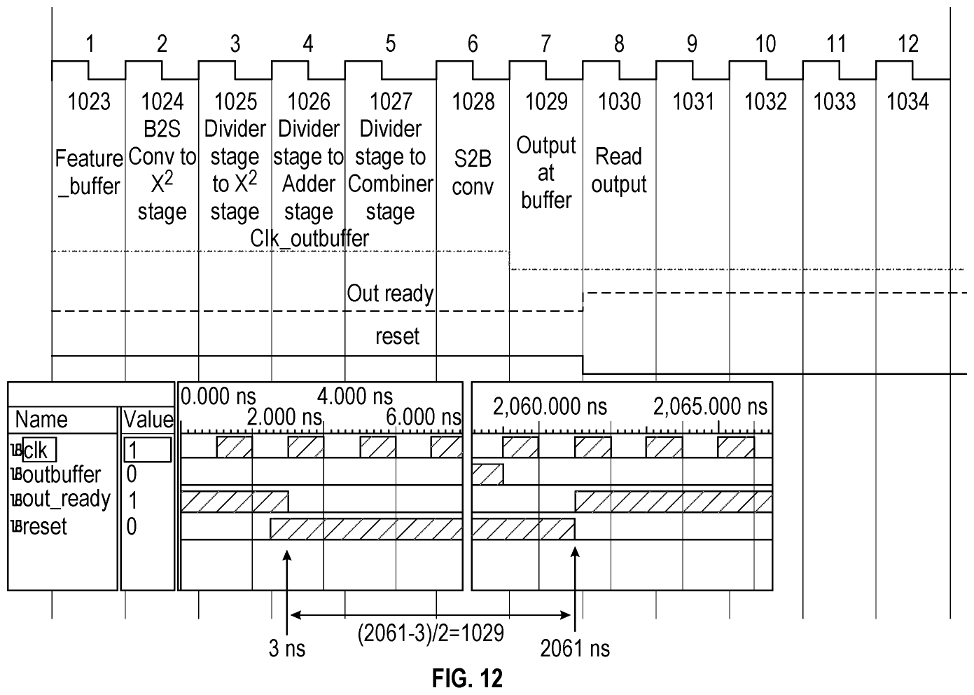

A simplified form of the modified timing diagram (e.g., shown in FIG. 11) with simulation is shown in FIG. 12.

### Feature Extraction and Integration of HIDS

Feature extraction is one of the important parts of HIDS, especially for detecting live incoming packets. In some implementations, one of the Linux utility tools such as tcpdump is used to intercept incoming packets. In some implementations, the raw information of the incoming packet cannot be used directly. Rather, a set of features required to be extracted from the incoming raw packet. In some implementations, during the training and preliminary testing, a popular data set namely, NSL-KDD, is used. Since this data set already has extracted features, testing of HIDS in live network necessitates the correct definition of these features. In some implementations, the features are extracted from incoming packets, the features are sent to the HIDS, the output from the HIDS is read, and finally, a decision whether to accept or reject the packet is made.

In some implementations, the functions (modules) are divided into software and hardware based modules. In some implementations, the software based modules do feature extraction, update weights, and perform decision making, while the hardware based modules run the SC HIDS process. In some implementations, in order to communicate between these software and hardware modules, an API compatible for FPGA (ASIC), called Advanced eXtensible Interface 4 (AXI4) interface, is used.

### Feature Extraction Module

In some implementations, for simplicity and effectiveness in the example below, all software modules run Python codes. Using the definition of NSL-KDD dataset, the features from incoming packets are extracted through the feature extraction module. A Python based packet sniffing utility called scapy is used to sniff incoming packet. This utility tool is MAC protocol independent, thus can sniff packet that may come through Ethernet or WIFI or any other interface. This packet sniffing and feature extracting software module will be sitting in the Processor System of FPGA (PS). A Python compatible FPGA is indispensable at this moment. In some implementations, a FPGA board named Ultra 96, which has all the required features is used to test the HIDS.

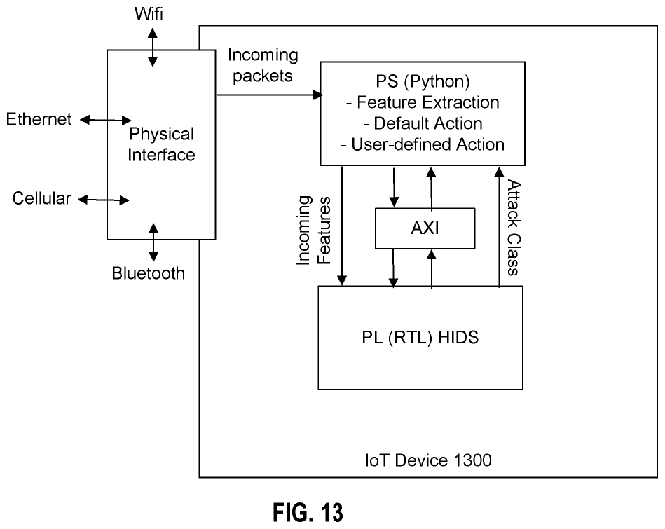

A schematic diagram for the complete HIDS is shown in FIG. 13.

### Integration of the HIDS

Python code is executed in the Processor System (PS) side of a System on Chip (SoC) FPGA. The communication between the software and the hardware HIDS is made possible with the help of AXI4 protocol interface. In order to hold the features and weights, two different AI4 modules are adopted. In this phase of HIDS, 15 (24−1) features, 2 hidden layers (deep NNA) each of which has 31 (25−1) neurons, and 4 (22) output classes are used. Since each feature is 10 bit long, a simple memory structure, such as a register, is used to hold its value. In some implementations, a lightweight AXI4 Lite module is sufficient to hold all the feature values. On the other hand, in some implementations, the total number of weights for the NNA is 1616 (16×31+32×31+32×4).

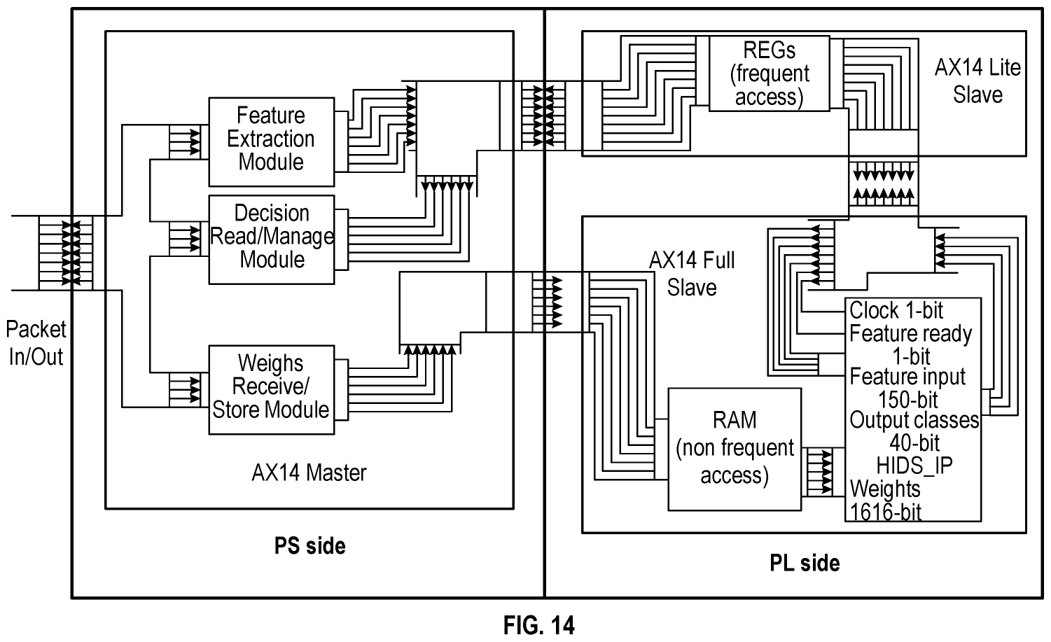

Therefore, in some implementations, AXI4 Full module is used to hold all the weights. In some implementations, at the end, the software module will send features of incoming packets and the updated weights through the AXI4 API to the hardware HIDS and the hardware HIDS will send the output classes to the software module using the reverse path of the AXI4 API. The detail diagram of the integration of the HIDS is shown in FIG. 14.

### Performance Evaluation and Proof of Concept Demo

Once the integration of the HIDS is complete, the performance evaluation is carried by training and testing data set of NSL-KDD. The results are compared with that of the Python based one to see the efficacy of the SC HIDS. The following table shows the comparative performance outcomes from Python and SC HIDS:

| Platform | Training data set | Testing data set |
|---|---|---|
| Python | 98-99% | 80-85% |
| SC HIDS | 98% | 80-85% |

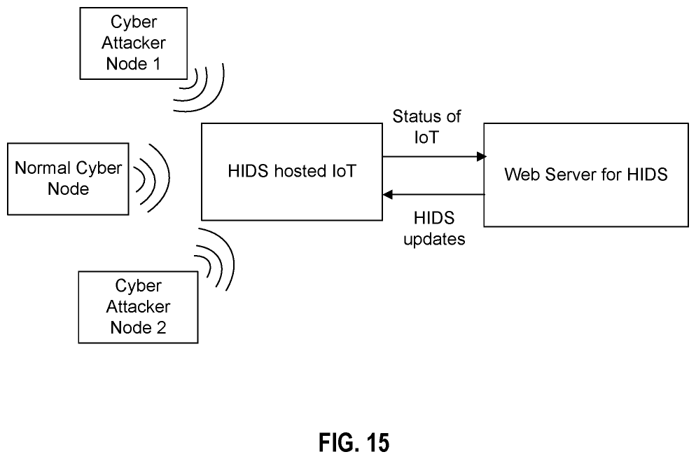

As the performance of the SC HIDS is essentially the same as the one with software based, the next step for this test is to utilize live packets from the real environment. In some implementations, an attack environment is created with the help of two Raspberry Pi Single Board Computers and two Laptop Computers. The attack environment is shown in FIG. 15.

In some implementations, the web server running on the laptop monitors the status of the connected HIDS hosted IoT device. The HIDS inside the host IoT device sends the status information to the web server to indicate whether the device in operating normal conditions or under a cyberattack. In some implementations, a user interface provides indications of incoming packets that displays whether the packet is normal or under attack. For example, normal operations are displayed with a first color (e.g., green) and operations that are under attack are displayed with a second color (e.g., red) to illustrate the status information to a user. In some implementations, the user is enabled to view additional connection details of an incoming packet, such as the IP address, product type, and other connection details.

According to the attack situation, the IoT device itself makes decision or it seeks assistance from the web server (e.g., illustrated in FIG. 15) for its next move.

In some implementations, a hardware based feature extraction can increase the speed and reduce the silicon space and the energy consumption significantly. A hardware based feature extraction can be accomplished in two layers: a) hardware based packet sniffing; and b) hardware based feature calculation from the raw packet. In some implementations, the first layer is implemented by an IC chip corresponding to the protocol in hand (e.g., Wifi, Bluetooth, LTE or customers' proprietary wireless interfaces). For example, an FPGA IP Core of a particular PHY interface is implemented. As for the second layer, in some implementations, the Xilinx Vivado HLS (High Level Synthesis) platform is used, where a C/C++ code can be converted to RTL (hardware). The definition of features can be implemented in C/C++ codes and later converted to hardware module.

In some implementations, any relevant IoT environment can be used in conjunction with the HIDS. However, each IoT environment has its own packet format and communication protocol. Therefore, each IoT requires its own HIDS training system. In fact, in some implementations, the HIDS is trained in a new environment. For example, training in a new environment includes steps such as: a) define features from incoming packets for the relevant IoT protocol; b) rank these features according to their Information Gain (IG); c) test SC NNA structure with these features using a software platform (e.g., C/C++, MATLAB); and d) find the best set of parameters for that relevant environment (e.g., number of features, number of hidden layers, number of neurons, etc.). Upon getting the parameters, a training system for the SC HIDS will be designed for training and preliminary testing.

In some implementations, the system described herein is integrated into a web-based integrated development environment (IDE). The core components of an IDE are as follows:
a) A web based Central Server (CS) that runs the training system and distributes the updates (automatically or manually) to each HIDS hosted inside an IoT device. It also provides the status of each IoT device (e.g., whether the device is working normal or under an attack).
b) HIDS hosted device holds an agent that sends new features to the training system for the upcoming training (adaptive).
c) Sends and receives updates and features between CS and IoT device through secure channel.

In some implementations, the disclosed system introduces a novel normalization block to accommodate Stochastic Computation (BC) based training in Binary Radix Computing (BC) domain (e.g., as described with reference to FIG. 1).

In some implementations, using the disclosed system, due to the normalization block, matrix multiplication in training and in Hardware HIDS produces the exact same result (e.g., as described with reference to FIG. 4B).

In some implementations, the disclosed system uses updated weights from training that are kept as discrete values of either +1 or −1 so that each weight of Hardware HIDS is either 1-bit 0 or 1-bit 1.

In some implementations, the disclosed system converts weight values from BC to SC does not require an independent hardware Random Number Generator (RNG). Thus, the number of weights is not restricted (e.g., making it a deep neural network) by the limited number of independent RNGs that can be created by hardware design.

In some implementations, the disclosed system introduces a novel activation function for the hidden layer, SCigmoid; which increases the nonlinearity margin in the training phase, thus significantly improving the SC training.

In some implementations, the disclosed SCigmoid function in SC hardware design produces the exact same result as in training (e.g., as described with reference to FIGS. 6-7).

In some implementations, the disclosed system introduces a novel activation function for the output layer, SCoftmax; which increases the non-linearity margin in the training phase, thus significantly improving the SC training.

In some implementations, the SCoftmax function in SC hardware design produces the exact same result as in training (e.g., as described with reference to FIGS. 8-9)

In some implementations, the disclosed system uses a hardware design of SC matrix multiplication that requires one independent RNG for each Multiplexer (MUX) stage without violating any SC (probability) rule (e.g., as described with reference to FIG. 5).

In some implementations, time synchronization is maintained among sub-blocks considering design delay and inherent physical delay to produce the correct output (e.g., as described with reference to FIGS. 10-12).

To that end, a method is provided for training a system using stochastic computation. The method is performed at an electronic device (e.g., an IoT device hosting HIDS, such as IoT Device 1300, or a HIDS server) that includes one or more processors and memory storing instructions for execution by the one or more processors for receiving a first set of inputs. The method includes training, using the first set of inputs, a stochastic neural network having a series of activation layers and an output layer, including: before passing the first set of inputs to first activation layer in the series of activation layers, normalizing each input in the first set of inputs; and propagating the outputs from the first activation layer as inputs to a second activation layer in the series of activation layers, wherein the inputs to the second activation layer are normalized before being passed to the second activation layer.

In some implementations, the method includes detecting a security threat to the electronic device using the trained stochastic neural network. For example, as illustrated in FIG. 15, cyber attacker node 1 and/or cyber attacker node 2 are detected by the HIDS hosted IoT, and prevent the IoT device (e.g., the electronic device) hosting HIDS from allowing the cyber attacker nodes access to the electronic device.

In some implementations, the method includes updating a display of a user interface for an application in accordance with the detected security threats. For example, a user interface is provided that displays whether packets (e.g., connections) received from one or more detected devices are considered as normal operation or considered as threats. In some implementations, in accordance with a determination that a respective packet is a threat, the electronic device automatically, without user input, rejects the packet.

In some implementations, normalizing each input in the first set of inputs comprises normalizing each input to have a value within a range of [+1, −1].

In some implementations, the method further includes, for each activation layer in the series of activation layers, normalizing each input in the respective set of inputs for the activation layer before passing the respective set of inputs to the respective activation layer.

In some implementations, training the stochastic neural network further comprises, during forward propagation, converting each weight to one of two possible values.

In some implementations, each weight is converted to +1 or −1 during forward propagation.

In some implementations, the method includes applying the trained stochastic neural network to a hardware system, wherein each weight in the neural network of the hardware system is 1-bit.

In some implementations, the hardware system converts weight values without using a random number generator.

In some implementations, a method for training a system using stochastic computation is provided. The method comprises training a stochastic neural network having a series of activation layers and an output layer, including applying an activation function to the series of activation layers having the form:

$$SCigmoid ( x ) = \frac{{( 1 + x )}^{2} - {( 1 - x )}^{2}}{{( 1 + x )}^{2} + {( 1 - x )}^{2}} ; where - 1 \leq x \leq + 1 .$$

In some implementations, a method for training a system using stochastic computation is provided. The method comprises training a stochastic neural network having a series of activation layers and an output layer, including applying an activation function to the output layer having the form:

$$SCoftmax ( {x}_{i} ) = \frac{ϕ ( {x}_{i} )}{{\sum }_{j}^{n} ϕ ( {x}_{j} )} ; where ϕ ( {x}_{i} ) = {( 1 + {x}_{i} )}^{2} .$$

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method for training a system using stochastic computation, comprising:
at an electronic device:
receiving a first set of inputs;
training, using the first set of inputs, a stochastic neural network having a series of activation layers and an output layer, including:
before passing the first set of inputs to first activation layer in the series of activation layers, normalizing each input in the first set of inputs; and
propagating the outputs from the first activation layer as inputs to a second activation layer in the series of activation layers, wherein the inputs to the second activation layer are normalized before being passed to the second activation layer.

2. The method of claim 1, wherein normalizing each input in the first set of inputs comprises normalizing each input to have a value within a range of [+1, −1].

3. The method of claim 1, further comprising, for each activation layer in the series of activation layers, normalizing each input in the respective set of inputs for the activation layer before passing the respective set of inputs to the respective activation layer.

4. The method of claim 1, wherein training the stochastic neural network further comprises, during forward propagation, converting each weight to one of two possible values.

5. The method of claim 4, wherein each weight is converted to +1 or −1 during forward propagation.

6. The method of claim 4, further comprising, applying the trained stochastic neural network to a hardware system, wherein each weight in the neural network of the hardware system is 1-bit.

7. The method of claim 6, wherein the hardware system converts weight values without using a random number generator.

8. An electronic device, comprising:
one or more processors; and
memory storing one or more programs for execution by the one or more processors, the one or more programs including instructions for:
receiving a first set of inputs;
training, using the first set of inputs, a stochastic neural network having a series of activation layers and an output layer, including:
before passing the first set of inputs to first activation layer in the series of activation layers, normalizing each input in the first set of inputs; and
propagating the outputs from the first activation layer as inputs to a second activation layer in the series of activation layers, wherein the inputs to the second activation layer are normalized before being passed to the second activation layer.

9. The electronic device of claim 8, wherein normalizing each input in the first set of inputs comprises normalizing each input to have a value within a range of [+1, −1].

10. The electronic device of claim 8, the instructions further including instructions for, for each activation layer in the series of activation layers, normalizing each input in the respective set of inputs for the activation layer before passing the respective set of inputs to the respective activation layer.

11. The electronic device of claim 8, wherein training the stochastic neural network further comprises, during forward propagation, converting each weight to one of two possible values.

12. The electronic device of claim 11, wherein each weight is converted to +1 or −1 during forward propagation.

13. The electronic device of claim 11, the instructions further including instructions for applying the trained stochastic neural network to a hardware system, wherein each weight in the neural network of the hardware system is 1-bit.

14. The electronic device of claim 13, wherein the hardware system converts weight values without using a random number generator.

15. A non-transitory computer-readable storage medium storing one or more programs for execution by an electronic device with one or more processors, the one or more programs including instructions for:
receiving a first set of inputs;
training, using the first set of inputs, a stochastic neural network having a series of activation layers and an output layer, including:
before passing the first set of inputs to first activation layer in the series of activation layers, normalizing each input in the first set of inputs; and
propagating the outputs from the first activation layer as inputs to a second activation layer in the series of activation layers, wherein the inputs to the second activation layer are normalized before being passed to the second activation layer.
